(19) United States
(12) Patent Application Publication
(10) Pub. No.: US 2005/0135586 A1
(43) Pub. Date: Jun. 23, 2005

(54) Virtual environment software tool kit, common operating control method and computer program product for IP telephony

(76) Inventor: John Kenneth Amick, Coconut Creek, FL (US)

Correspondence Address: JOHN KENNETH AMICK, 980 NW 49TH WAY, COCONUT CREEK, FL, 33063, US

(21) Appl. No.: 10/938,638

(22) Filed: Sep. 13, 2004

Related U.S. Application Data
(63) Continuation-in-part of application No. 09/556,439, filed on Apr. 24, 2000.

(51) Int. Cl. H04M 3/42

(52) U.S. Cl. 379/201.1

(57) ABSTRACT

The use of software-based Objects allows the rapid and accurate configuration, manipulation and/or destruction of virtual environment applications that networks subscribers together, processes calls, enables messaging, and provides disaster avoidance.

### CROSS REFERENCE TO RELATED APPLICATIONS

The present Continuation In Part document (hereinafter referred to as “CIP”) claims the benefit of the earlier filing date of, and contains subject matter related to that disclosed in the issued U.S. Pat. No. 6,088,437, dated Jul. 11, 2000 (hereinafter referred to as “CALL PULL-BACK”), and co-pending U.S. patent Attorney Docket No. 8006-0019-13, Confirmation No. 7593, application Ser. No. 09/556,439, entitled “A VIRTUAL VOICE NETWORK TOOL KIT, METHOD AND COMPUTER PROGRAM PRODUCT,” filed in the United States Patent and Trademark Office on Apr. 23, 1999, having common inventorship by John Kenneth Amick, the entire contents of all of which being incorporated herein by reference.

### BACKGROUND OF THE INVENTION

### Field of the Invention

The present invention pertains to applications servers and computer-based products used for telephony, multi-media messaging, (voice mail, e-mail, fax, instant_messaging, etc.), electronic document sharing, and the storage of electronic documents in secured locations, video and voice conferencing, plug in applications modules as well as disaster protection in a “virtual environment,” hereby referred to as an “application.” In addition, these applications provide services that are differentiated from other services that allow telephony, multi-media messaging and or electronic document sharing and storage in that they typically employ CALL PULL-BACK technology to accomplish telephony Call Processing in the Public Switch Telephone Network (PSTN) and in the use of an applications tool kit and common operating control comprised of preprogrammed software constructs hereby referred to as “Objects.”

Applications are housed in geographically diverse, strategically located hardened sites called Network Operations Control Centers (NOCCS) and provide disaster protection by answering calls and allowing callers to be redirected to the called party's_last known location. This is accomplished through the use of Presence. The called party logs on to the network from a Session Initiation Protocol (SIP) compatible device. The network makes note of the address of the device from which the call came and redirects future incoming traffic to that device until the next log on occurs. This may be used in conjunction with a type of “call follow me” and messaging. The network is private and the digital portion is encrypted. Everything is hardened against manmade or natural disasters and applications and messaging are mirrored from NOCC to NOCC. This is -coupled with the ability to process calls from any device to any other device (analog, IP or cell phone, personal computer or PDA) in the event of an emergency. Multi-media messaging and/or document sharing is used to seamlessly network together a client's staff even when that staff is deployed in multiple remote locations. More particularly, the present invention is directed toward application development tools, Objects and the methods used to create, manipulate and/or destroy these virtual environments. Telephone calls are processed across a private IP network layered on top of a self healing optical network. Callers may be offered options when a call they initiate encounters a no answer condition.

### DISCUSSION OF THE BACKGROUND

Advances in communications (e.g., cellular telephones, PDAs and the Internet), the increased mobilization of the work force, the threat of manmade or natural disasters_and the desire of individuals to work securely from virtual environments have all fueled the need for integrated communications services. These services often include the voice and data networking of employees and others working outside the traditional office environment. Subscribers may place calls, send, receive and manipulate multi-media messaging, share documents, and allow callers to access members of these networks no matter where they are located. Calls may be placed across the Public Switch Telephone Network (PSTN) or a private IP network. The caller need never know that the person they are calling is working from a remote location or from home.

A client company or governmental unit's (“client”) ability to continue functioning after suffering a disaster is greatly enhanced since the equipment hosting their application is located in multiple hardened sites built to operate under extremely adverse conditions. The digital portion of the network is layered on a self-healing optical network. Wherever possible, equipment is engineered to fail over to backup equipment. Applications and messaging are mirrored from NOCC to NOCC. The routing of callers to the main greeting of a client's application occurs at the TELCO Central Office on a busy, forward or no answer condition. If the original call was to a company rather than an individual, the caller could enter an extension number or select from a menu and be transparently connected to an employee of the client. The caller is given further options if the call encounters a busy or no answer condition. Clients may access other clients on the corporate or government network much like they would in a traditional office. The challenge has been to create the tools and methods and documentation that enable the construction, maintenance and destruction of these networks in a rapid and reliable manner.

### SUMMARY OF THE INVENTION

An objective of the present invention is to address the matters described in the “Discussion of the Background.” While the next section addresses specific features and attributes of the invention, a brief non-exhaustive description of the invention is now presented. The present invention provides a software tool kit; a computer based business method and services sold as products, which may be deployed by various means disclosed within this document.

The chief attribute of the invention is a software tool kit and common operating control known as the Objects. In a previous version of the network, in the issued U.S. Pat. No. 6,088,437, dated Jul. 11, 2000, and in co-pending U.S. patent Attorney Docket No. 8006-0019-13, Confirmation No. 7593, application Ser. No. 09/556,439, entitled “A VIRTUAL VOICE NETWORK TOOL KIT, METHOD AND COMPUTER PROGRAM PRODUCT,” filed in the United States Patent and Trademark Office on Apr. 23, 1999, having common inventorship, the entire contents of all of which being incorporated herein by reference, the “Objects” resided in the Call Processor and Integrated Voice Response (IVR) portion of the NOCC. In this CIP, the “Objects” reside primarily in the SIP and Authentication servers. As the network evolves and technology changes, the “Objects” are rewritten. What remains the same or slowly changes over time in the underlying functionality of each Object. In general, the devices or servers that can be programmed and have the ability to issue commands to other devices or servers may be used.

Depending on the business needs of the client, the Objects may work in conjunction with the invention described and disclosed in the issued U.S. Pat. No. 6,088,437, dated Jul. 11, 2000 (“CALL PULL-BACK”), and in co-pending U.S. patent Attorney Docket No. 8006-0019-13, Confirmation No. 7593, application Ser. No. 09/556,439, entitled “A VIRTUAL VOICE NETWORK TOOL KIT, METHOD AND COMPUTER PROGRAM PRODUCT,” filed in the United States Patent and Trademark Office on Apr. 23, 1999, having common inventorship, the entire contents of all of which being incorporated herein by reference, a copy of each of which is included in the Appendix. As previously mentioned, Objects are preprogrammed software constructs that when used in conjunction with one another allow a non-technical person who may understand only the business needs of a client to rapidly and reliably create, manipulate and/or destroy an application. These applications/virtual environments work in different ways. In some cases they stand behind the client answering calls that are forwarded in under a busy or no answer condition. In other cases the client may not have a physical headquarters. Callers go directly to the application and the application then routes calls and provides messaging, video and voice conferencing services.

While more common methods are used to market these products/applications, another attribute of the invention is to package the products as a boxed software package commonly found on store shelves and marketed on the Internet. The consumer purchasing the appropriate level of a virtual environment from a store or web site may then order the desired configuration or upgrade needed on a web site authorized to sell the products. The applications process switched circuit voice calls, H-320/ISDN video/voice conferencing traffic, IP/H-323 and Session Initiation Protocol (SIP) to and from a Media Gateway Control (MEGACO) cloud while the SIP presence is handled in the soft switch.

### BRIEF DESCRIPTION OF THE DRAWINGS

A more complete appreciation of the invention and many of the attendant advantages thereof will be readily apparent as the same becomes better understood. To assist in this understanding, the following is provided as a reference to the detailed descriptions to be considered in connection with the accompanying drawings located in the Appendix, wherein:

FIG. 1 is a diagram of a method used to implement the network.

FIG. 2 is a diagram of one of the Network Operation Control Centers (NOCCS).

### BRIEF DESCRIPTION OF THE APPENDIX

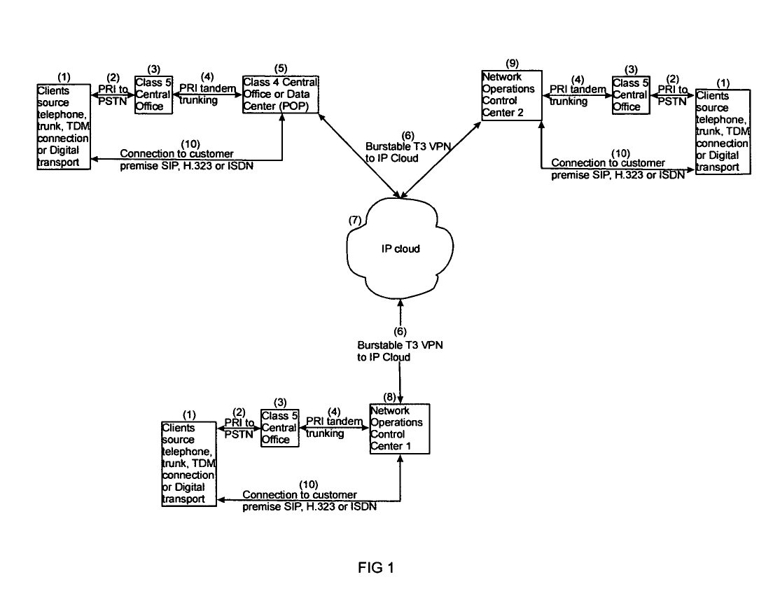

An appendix is attached hereto that contains FIGS. 1, 2 and 10, as well as a copy of the issued U.S. Pat. No. 6,088,437, dated Jul. 11, 2000 (“CALL PULL-BACK”), and co-pending U.S. patent Attorney Docket No. 8006-0019-13, Confirmation No. 7593, application Ser. No. 09/556,439, entitled “A VIRTUAL VOICE NETWORK TOOL KIT, METHOD AND COMPUTER PROGRAM PRODUCT,” filed in the United States Patent and Trademark Office on Apr. 23, 1999, having common inventorship.

### DESCRIPTION OF THE PREFERRED EMBODIMENTS

Referring now to the drawings, wherein numerals indicate corresponding parts of the network:

FIG. 1 is a diagram of the network.

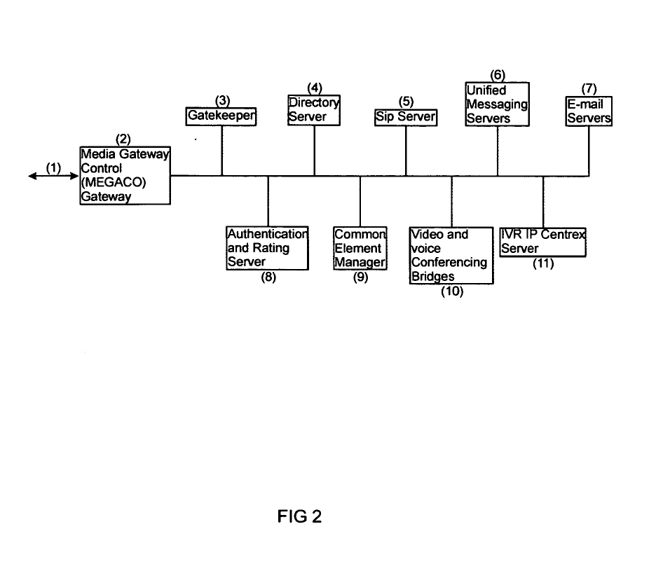

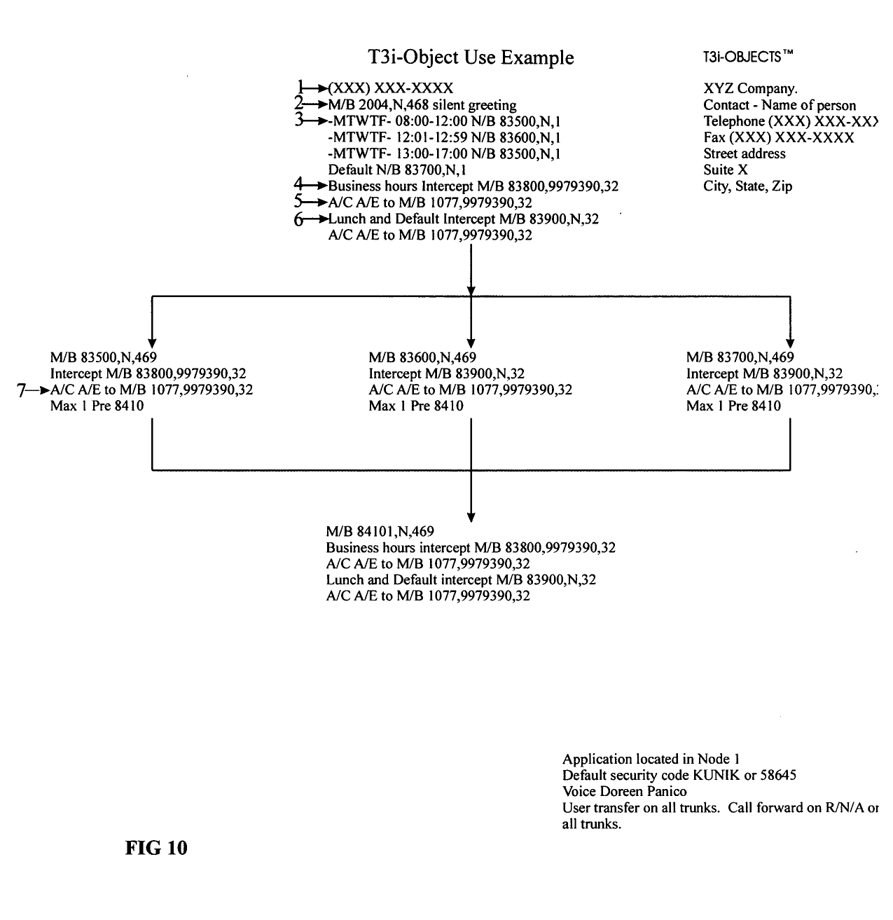

(1) Represents the client's premise. Lines, trunks, time division multiplexing (TDM) or digital transport can provide connectivity to the network. A caller may trigger the application by directly dialing the DID or DNIS number, or by using caller ID, a pin number, or voice recognition. In the event DID, DNIS or caller ID is used, a translation on the incoming identification number may or may not be performed in order to accommodate a desired numbering plan. In addition, a caller may be forwarded into the application because all of the client's lines are busy, no one answers, or someone at the company transfers the caller in. Once the identifying string is received, the correct application is started and Objects provide the needed resources. The appropriate greeting is then played to the caller. The caller may send, receive or manipulate a mixed media message. The caller dials an extension, spells out some letters of a name, or otherwise makes a selection that dials a remote telephone number. The caller is processed across the PSTN, Internet, Leased Lines, wireless, etc., to a remote destination telephone where CALL PULL-BACK may come into play. CALL PULL-BACK is disclosed in the issued U.S. Pat. No. 6,088,437, dated Jul. 11, 2000), and in co-pending U.S. patent Attorney Docket No. 8006-0019-13, Confirmation No. 7593, application Ser. No. 09/556,439, entitled “A VIRTUAL VOICE NETWORK TOOL KIT, METHOD AND COMPUTER PROGRAM PRODUCT,” filed in the United States Patent and Trademark Office on Apr. 23, 1999, having common inventorship, the entire contents of all of which being incorporated herein by reference. A client may or may not have a PBX. If they do have a PBX, the PBX may be programmed so that all or part of their traffic may use the network. A client may have a digital connection to the Point of Presence (POP), such as an Ethernet connection. If they do, switched circuit traffic may then be converted to digital traffic by a device located on or about the client's premise. In the event a caller does not have a PBX, IP Centrex or IP phones may be used. Video conferencing transport may be ISDN or IP.
(2) Represents leased PRI connectivity to the Public Switched Telephone Network (PSTN).
(3) Multiple strategically located Class 5 switches in each LATA allowing all inbound and outbound traffic to be considered local traffic by the Incumbent Local Exchange Carrier (ILEC).
(4) Leased PRI tandem trunking connecting each Class 5 CO to . . .
(5) . . . a Gateway located in the Local Exchange Carriers (LECS) Class 4 Central Office or Data Center. The gateways are Points of Presence (POPs).
(10) The connection to a client's premise may be Session Initiated Protocol (SIP), H-323 over Ethernet or ISDN, all of which are native to the gateway eliminating any need for protocol converters and mediators.
(6) Represents a scalable, burstable Media Gateway Control (MEGACO) VPN to the IP cloud starting off with a T3 connection and expanding throughput as needed.
(7) IP cloud (MEGACO).
(8) Network Operations Control Center (NOCC) number 1. A NOCC also functions as a POP in the LATA in which it is located. NOCCs are connected by a self-healing optical network capable of withstanding a nuclear incident and spread out over large geographical distances. Each NOCC mirrors another NOCC's messaging and data. In addition, each NOCC provides a hot standby fail-over should a NOCC be rendered inoperable by a natural or manmade disaster. NOCCs contain the various servers and software needed to host the applications. (See FIG. 2 located in the appendix.)
(9) Network Operations Control Center (NOCC) number 2 provides services to its share of clients as well as mirroring the messaging and data of NOCC 1 and providing a hot standby fail-over for NOCC 1. To clarify, only NOCC 1 and 2 are shown on the drawing, but in reality there are as many NOCCs as are needed.

FIG. 2 is a diagram clarifying the NOCC components,
(1) Incoming traffic from the POPs to the gateway.
(2) Media Gateway Control (MEGACO) Gateway.
(3) Gatekeeper: Pin prefix, account name, phone number, IP address, etc.
(4) Directory server: Central repository for storing and managing identity profiles and access privileges.
(5) SIP server which hosts SIP related applications.
(6) Unified Messaging Servers: Mixed media messaging.
(7) E-mail servers.
(8) Authentication and rating server, which hosts Softswitch applications.
(9) Common element manager: The Java-based graphical user interface (GUI) for managing individual network devices.
(10) Video and voice conferencing bridges.
(11) IVR IP Centrex server provides IP Centrex services for clients who have no PBX.

### DESCRIPTION OF OBJECTS

An Object is a proven, preprogrammed software construct which by itself or when assembled with other Objects provides a desired functionality. Objects are written in traditional programming languages, scripting languages, and high-level command line code. The Objects allow non-technical personnel who understand the business needs of a client to rapidly and accurately create, manipulate and/or destroy these virtual environments.

Objects operate in conjunction with parameters, tables, attributes, classes, routines, methods, compiled code etc. which control the various components in the NOCCs and POPs. Objects perform the various functions so that the needs of the client are satisfied. The creator of a virtual environment places clients' mailboxes in Classes of Service that have been pre-configured as Objects. When services from other Servers are needed, the Objects furnish those services in the appropriate manner. If switching services are required, the Objects will issue commands to the Switch for functions such as routing a call. As with any product in the computer/telephony world, the Objects are constantly evolving.

Hardware changes require the rewriting of the “Objects” in new languages. Therefore, a living document has been created describing the functionality and services provided by each Object rather than lines of code. Once the functionality is specified, it is a simple matter to rewrite each Object. Personnel responsible for the creation of virtual environment applications use the documentation that starts on page 11. The Objects used to create a given virtual environment have the explanation of the functionality and services of the Object under the heading of each Class of Service (COS) or Object (OBJ). The Object itself is not a Class of Service; it is all of the preprogrammed and tested software comprising that construct. This ability alone allows the offering of inexpensive, reliable, custom virtual environments in a very rapid and cost effective manner.

Cost effectiveness is an important reason that others are not building sophisticated custom configurations for large numbers of clients. Without the use of the Objects, their personnel would have to program each configuration from scratch. The best way to define a given Object is to define its functions. One of the unique features of an Object is that a single instance of a given Object can operate at the same time on one or more physical platforms having different operating systems. Each Object is made up of many components.

### Object/Class of Service Documentation

| OBJECT/ | |
|---|---|
| CLASS OF | |
| SERVICE | FUNCTION OF OBJECT/CLASS OF SERVICE |
| OBJ/COS 0 | Unassigned D.I.D. mailboxes. NOTE: A silent D.I.D. mailbox greeting must be |
| | recorded. |
| | Non area code specific Object. |
| | Description: |
| | The number of a mailbox placed in this Object matches the number that will be |
| | received by the relevant portion of the POP or NOCC after any and all translations |
| | are accomplished. This number is generated when a caller reaches a telephone |
| | number issued to a client. As numbers in Object 0 are not currently issued but are |
| | defined and can still be reached from the outside world, they are kept in Object 0. |
| | When one of these numbers is dialed, the following recording is played: “You have |
| | reached an unassigned telephone number, please hang up and try again”. No |
| | input is accepted from the caller. No message is taken which prevents unwanted |
| | messages such as those left by automatic dialers from consuming storage. The |
| | caller hears, “Goodbye” and is dropped. |
| OBJ/COS 1 | Company greetings, no associated extension or telephone number, no messages |
| | may be recorded. Play greeting twice and disconnect. |
| | Non area code specific Objects. |
| | Description: |
| | The caller hears a recorded message and may enter an extension number or select |
| | a menu choice. No numbers are dialed automatically upon a caller reaching this |
| | mailbox. If the caller takes no action, the greeting is played twice and the caller is |
| | dropped. |
| OBJ/COS 2 | Disconnect from caller. Play silent greeting and hang up. No input is accepted |
| | from the caller. |
| | Non area code specific Object. |
| | Description: |
| | Commonly used as part of a configuration where there is a need to play a |
| | recording and while the recording is being played, allow the user to take an action |
| | such as entering an extension number or making a choice. If no selection or |
| | choice is made after the recording is played, there is a moment of silence while the |
| | caller is moved to a mailbox and placed in Object 2 where they may or may not |
| | hear a second recording depending on the application desired. No input is |
| | accepted from the caller. After the moment of silence or the second recording is |
| | played, the caller is dropped. |
| OBJ/COS 3 | Company greetings, no associated extension or telephone number, no messages |
| | may be recorded. Play greeting and disconnect. |
| | Non area code specific Object. |
| | Description: |
| | The caller hears a recorded message and may enter an extension number or select |
| | a menu choice. If the caller takes no action, the caller is dropped. |
| OBJ/COS 4 | Object dedicated to one of a kind, client specific application. |
| | Description: |
| | If caller presses a 0, a ring all hunt group is activated. |
| OBJ/COS 5 | Voice Response Server prompt mailboxes. |
| | Store recordings used by the Voice Response Server. |
| | Description: |
| | Store recordings used by the Voice Response (IVR) portion of the POP or NOCC. |
| OBJ/COS 6 | Pilot mailbox for Voice Response, (IVR) Server message pool. |
| | Store recordings used by the Voice Response Server application processor. |
| | Description: |
| | The lead mailbox number of a list of mailboxes responsible for the storage of |
| | application controlled messages. |
| OBJ/COS 7 | Fax only with voice annotation. |
| | Non area code specific Object. |
| | Description: |
| | Any mailbox placed in this Object will accept only a fax with or without voice |
| | annotation. User input is accepted. |
| OBJ/COS 8 | Voice Response Server Error mailbox. |
| | Store error recording used by the Voice Response Server, (IVR) application |
| | processor. |
| | Description: |
| | Any mailbox placed in this Object is an error-handling mailbox for the Voice |
| | Response Server, (IVR) portion of the POP or NOCC. User input is accepted. |
| OBJ/COS 9 | Fax on demand. Prints the first fax in each mailbox. |
| | Non area code specific Object. |
| | Description: |
| | Prints only the first fax stored in a mailbox placed in this Object. |
| OBJ/COS 10 | Application Processor control. |
| | Non area code specific Object. |
| | Description: |
| | Takes the caller to Application Processor Control. A caller that reaches a mailbox |
| | in this Object is provided services by the Voice Response Server, (IVR) |
| | application associated with that mailbox which acts as a call identification |
| | number. |
| OBJ/COS 11 | Plays greeting once; after greeting plays, use extension number for next |
| | mailbox. |
| | Non area code specific Object. |
| | Description: |
| | Normally used to play a recording once which may give the caller enough time to |
| | take an action such as dialing an extension or selecting a choice. After greeting |
| | plays or if the caller takes no action, the caller is moved to a different part of the |
| | application. Also used as a way to rapidly and automatically move a caller from |
| | one mailbox to another. |
| OBJ/COS 12 | Play greeting twice; after greeting plays, use extension number for next mailbox. |
| | Non area code specific Object. |
| | Description: |
| | Normally used to play a recording twice, which may give the caller enough time to |
| | take an action such as dialing an extension or selecting a choice. After greeting |
| | plays or if the caller takes no action, the caller is moved to a different part of the |
| | application. Also used as a way to rapidly and automatically move a caller from |
| | one mailbox to another. |
| OBJ/COS 13 | Block access to system distribution pilot numbers. |
| | Non area code specific Object. |
| | Description: |
| | Access to a distribution list whose pilot number is placed in this Object is |
| | restricted to users with special mailbox programming. |
| OBJ/COS 14 | Fax overflow mailboxes (M/Bs). |
| | Non area code specific Object. |
| | Description: |
| | Used to provide a “fax store and forward” service to a client. When a fax machine |
| | on the client's premise is busy or no answer, the caller is forwarded to a mailbox |
| | in this Object that provides fax tone, takes a fax, and repeatedly attempts to deliver |
| | that fax back to the originally called fax machine until successful. |
| OBJ/COS 15 | Call number first before playing greeting, record message option. Offsite only if |
| | urgent. May receive fax. |
| | Object dedicated to one of a kind, client specific application. |
| | Description: |
| | Ring an extension; if busy or no answer, play a greeting, take a message, and |
| | activate “off site message waiting” if the caller marked the message urgent. In |
| | addition, a mailbox placed in this Object will accept a fax. While listening to the |
| | greeting the caller may enter an extension number or select a choice. |
| OBJ/COS 16 | Call number first before playing greeting, record message option, station has |
| | multiple mailboxes; ask before connecting. Offsite only if urgent. May receive |
| | fax. |
| | Object dedicated to one of a kind, client specific application. |
| | Description: |
| | Ring a phone; if answered announce the call, if busy or no answer, play a greeting, |
| | take a message, and activate “off site message waiting” if the caller marked the |
| | message urgent. In addition, a mailbox placed in this Object will accept a fax. |
| | While listening to the greeting the caller may enter an extension number or select |
| | a choice. |
| OBJ/COS 17 | “Greeting on” stops numbers from being dialed, record message option. Offsite |
| | only if urgent. May receive fax. |
| | Object dedicated to one of a kind, client specific application. |
| | Description: |
| | Recording a greeting and turning the greeting on stops the extension number |
| | associated with a mailbox in this Object (if one exists) from being dialed. |
| | Mailbox will take a message and activate “off site message waiting” if the caller |
| | marked the message urgent. In addition, a mailbox placed in this Object will |
| | accept a fax. While listening to the greeting the caller may enter an extension |
| | number or select a choice. |
| OBJ/COS 18 | Professional voice. |
| | Object dedicated to one of a kind, client specific application. |
| | Description: |
| | Along with the normal features and functions given most users, a Mailbox placed |
| | in this Object has the privilege of being able to name mailboxes. Recording a |
| | greeting and turning the greeting on stops the extension number associated with a |
| | mailbox in this Object (if one exists) from being dialed. While listening to the |
| | greeting the caller may enter an extension number or select a choice. |
| OBJ/COS 19 | Forms. |
| | Object dedicated to one of a kind, client specific application. |
| | Description: |
| | This Object provides specific customers with an application that asks a series of |
| | questions one at a time and records the answers the caller gives in their own voice. |
| | After the questions are asked, the caller is given the option of reviewing their |
| | answers and re-recording them if so desired. Upon acceptance of the answers by |
| | the caller, the answers to the questions are placed in a mailbox specified by the |
| | client for further action. |
| OBJ/COS 21 | Page every time a message is left. |
| | Object dedicated to one of a kind, client specific application. |
| | Description: |
| | When placed in this Object, a mailbox with an internal extension will activate a |
| | pager every time a message is left during user specified time periods. Recording a |
| | greeting and turning the greeting on stops the extension number associated with a |
| | mailbox in this Object (if one exists) from being dialed. While listening to the |
| | greeting the caller may enter an extension number or select a choice. |
| OBJ/COS 30 | Local call, call number first before playing greeting, record message option. |
| | Non area code specific Objects. |
| | Description: |
| | A mailbox placed in this Object will call an external telephone number without |
| | dialing an area code and if not answered, will play a greeting and record a |
| | message. While listening to the greeting the caller may enter an extension number |
| | or select a choice. |
| OBJ/COS 31 | Local call, call number first before playing greeting, record message option. |
| | Station has multiple mailboxes; ask before connecting. |
| | Non area code specific Objects. |
| | Description: |
| | Dial a telephone number without dialing an area code; if answered, announce the |
| | call; if busy or no answer, play a greeting and take a message. While listening to |
| | the greeting the caller may enter an extension number or select a choice. |
| OBJ/COS 32 | Local call, “greeting on” stops numbers from being dialed, record message option. |
| | Non area code specific Objects. |
| | Description: |
| | Recording a greeting and turning the greeting on stops the telephone number |
| | associated with a mailbox in this Object (if one exists) from being dialed. When |
| | the user turns off the greeting, a mailbox placed in this Object will ring a phone |
| | without dialing an area code. The mailbox will take a message. While listening to |
| | the greeting the caller may enter an extension number or select a choice. |
| OBJ/COS 33 | Local call, call number first before playing greeting, record message option. |
| | Offsite only if urgent. May receive Fax. |
| | Non area code specific Objects. |
| | Description: |
| | Ring a phone without dialing an area code; if busy or no answer, play a greeting |
| | and take a message. Mailbox will take a message and activate “off site message |
| | waiting” if the caller marked the message urgent. In addition, a mailbox placed in |
| | this Object will accept a fax. While listening to the greeting the caller may enter |
| | an extension number or select a choice. |
| OBJ/COS 34 | Local call, call number first before playing greeting, record message option. |
| | Station has multiple mailboxes; ask before connecting. Offsite only if urgent. |
| | May receive Fax. |
| | Non area code specific Objects. |
| | Description: |
| | Ring a phone without dialing an area code. If answered, the call will be |
| | announced and the called party will be given the option to accept or reject the call. |
| | If busy or no answer, a greeting may be played and a message taken. Mailbox will |
| | take a message and activate “off site message waiting” if the caller marked the |
| | message urgent. In addition, a mailbox placed in this Object will accept a fax. |
| | While listening to the greeting the caller may enter an extension number or select |
| | a choice. |
| OBJ/COS 35 | Local call, “greeting on” stops numbers from being dialed, record message option. |
| | Offsite only if urgent. May receive Fax. |
| | Non area code specific Objects. |
| | Description: |
| | Recording a greeting and turning the greeting on stops the telephone number |
| | associated with a mailbox in this Object (if one exists) from being dialed. When |
| | the user turns off the greeting, a mailbox placed in this Object will ring a phone |
| | without dialing an area code. Mailbox will take a message and activate “off site |
| | message waiting” if the caller marked the message urgent. In addition, a mailbox |
| | placed in this Object will accept a fax. While listening to the greeting the caller |
| | may enter an extension number or select a choice. |
| OBJ/COS 36 | Local call, blind transfer. |
| | Non area code specific Objects. |
| | Description: |
| | A mailbox in this Object will dial a telephone number without dialing an area code |
| | and then perform a blind transfer. The caller may dial no numbers and no |
| | messages may be recorded. |
| OBJ/COS 37 | Local call, call number first before playing greeting, no messages, play greeting |
| | twice, allow user to dial. |
| | Non area code specific Objects. |
| | Description: |
| | A mailbox in this Object will dial a telephone number without dialing an area |
| | code; if busy or no answer, the greeting will play twice, the user will be allowed to |
| | dial an extension or select a choice, no messages may be recorded. |

The following is an example of a set of area code specific Objects. For clarity, only one set of area code specific Objects are shown.

| | |
|---|---|
| OBJ/COS 50 | (305) area code call; call number first before playing greeting, record message |
| | option. |
| | Area code specific Objects. |
| | Description: |
| | A mailbox placed in this Object will dial a “1” and the above area code before |
| | calling an external telephone number. If the call is not answered the mailbox will |
| | play a greeting and record a message. While listening to the greeting the caller |
| | may enter an extension number or select a choice. |
| OBJ/COS 51 | (305) area code call; call number first before playing greeting, record message |
| | option. Station has multiple mailboxes; ask before connecting. |
| | Area code specific Objects. |
| | Description: |
| | A mailbox placed in this Object will dial a “1” and the above area code before |
| | calling an external telephone number. If answered, it will announce the call; if |
| | busy or no answer, it will play a greeting and take a message. While listening to |
| | the greeting the caller may enter an extension number or select a choice. |
| OBJ/COS 52 | (305) area code call; “greeting on” stops numbers from being dialed, record |
| | message option. |
| | Area code specific Objects. |
| | Description: |
| | Recording a greeting and turning the greeting on stops the telephone number |
| | associated with a mailbox in this Object (if one exists) from being dialed. When |
| | the greeting is turned off by the user, a mailbox placed in this Object will dial a |
| | “1” and the above area code before calling an external telephone number. The |
| | mailbox will take a message. While listening to the greeting the caller may enter |
| | an extension number or select a choice. |
| OBJ/COS 53 | (305) area code call; call number first before playing greeting, record message |
| | option. Offsite only if urgent. May receive Fax. |
| | Area code specific Objects. |
| | Description: |
| | A mailbox placed in this Object will dial a “1” and the above area code before |
| | calling an external telephone number. If busy or no answer, play a greeting and |
| | take a message. Mailbox will take a message and activate “off site message |
| | waiting notification” if the message was marked urgent. In addition, a mailbox |
| | placed in this Object will accept a fax. While listening to the greeting the caller |
| | may enter an extension number or select a choice. |
| OBJ/COS 54 | (305) area code call; call number first before playing greeting, record message |
| | option. Station has multiple mailboxes; ask before connecting. Offsite only if |
| | urgent. May receive Fax. |
| | Area code specific Objects. |
| | Description: |
| | A mailbox placed in this Object will dial a “1” and the above area code before |
| | calling an external telephone number. If answered, the call will be announced and |
| | the called party will be given the option to accept or reject the call. If busy or no |
| | answer, a greeting may be played and a message taken. Mailbox will take a |
| | message and activate “off site message waiting if the message was marked urgent. |
| | In addition, a mailbox placed in this Object will accept a fax. While listening to |
| | the greeting the caller may enter an extension number or select a choice. |
| OBJ/COS 55 | (305) area code call; “greeting on” stops numbers from being dialed, record |
| | message option. Offsite only if urgent. May receive Fax. |
| | Area code specific Objects. |
| | Description: |
| | Recording a greeting and turning the greeting on stops the telephone number |
| | associated with a mailbox in this Object (if one exists) from being dialed. When |
| | the greeting is turned off by the user, a mailbox placed in this Object will dial a |
| | “1” and the above area code before calling an external telephone number. Mailbox |
| | will take a message and activate “off site message waiting” if the caller marked the |
| | message urgent. In addition, a mailbox placed in this Object will accept a fax. |
| | While listening to the greeting the caller may enter an extension number or select |
| | a choice. |
| OBJ/COS 56 | (305) area code call; blind transfer. |
| | Area code specific Objects. |
| | Description: |
| | A mailbox placed in this Object will dial a “1” and the above area code before |
| | calling an external telephone number and performing a blind transfer. No |
| | numbers may be dialed by the caller and no messages may be recorded. |
| OBJ/COS 57 | (305) area code call; call number first before playing greeting, no messages, play |
| | greeting twice, allow user to dial. |
| | Area code specific Objects. |
| | Description: |
| | A mailbox placed in this Object will dial a “1” and the above area code before |
| | calling an external telephone number. If the number is busy or no answer, a |
| | greeting will play twice and the user will be allowed to dial an extension or select |
| | a choice; no messages may be recorded. |

### Additional Objects

| | |
|---|---|
| OBJ/COS 455 | Object dedicated to one of a kind, client specific application. |
| | Description: |
| | Ring a phone without dialing an area code. If answered, the call will be |
| | announced and the called party will be given the option to accept or reject the call. |
| | If busy or no answer, a greeting may be played and a message taken. Mailbox will |
| | take a message and activate “off site message waiting” if the caller marked the |
| | message urgent. In addition, a mailbox placed in this Object will accept a fax. |
| | While listening to the greeting the caller may enter an extension number or select |
| | a choice. |
| | This Object provides a special dynamic call blocking service to the company. |
| | When a caller enters a universal port they are given a numeric value that stays |
| | with them for the duration of the call. The caller may only reach an Object with |
| | the same numeric value or a “0” value. |
| OBJ/COS 456 | Object dedicated to one of a kind, client specific application. |
| | Description: |
| | Takes the caller to Application Processor Control. A caller that reaches a mailbox |
| | in this Object is taken to the IVR application associated with that mailbox which |
| | acts as a call identification number. |
| | This Object provides a special dynamic call blocking service to the company. |
| | When a caller enters a universal port they are given a numeric value that stays |
| | with them for the duration of the call. The caller may only reach an Object with |
| | the same numeric value or a “0” value. |
| OBJ/COS 457 | (800) area code. |
| | Object dedicated to one of a kind, client specific application. |
| | Description: |
| | A mailbox placed in this Object will dial a “1” and the above area code before |
| | calling an external telephone number. If answered, it will announce the call; if |
| | busy or no answer, it will play a greeting and take a message. While listening to |
| | the greeting the caller may enter an extension number or select a choice. |
| | This Object provides a special dynamic call blocking service to the company. |
| | When a caller enters a universal port they are given a numeric value that stays |
| | with them for the duration of the call. The caller may only reach an Object with |
| | the same numeric value or a “0” value. |
| OBJ/COS 458 | Object dedicated to one of a kind, client specific application. |
| | Description: |
| | Recording a greeting and turning the greeting on stops the telephone number |
| | associated with a mailbox in this Object (if one exists) from being dialed. When |
| | the user turns off the greeting, a mailbox placed in this Object will ring a phone |
| | without dialing an area code. Mailbox will take a message. While listening to the |
| | greeting the caller may enter an extension number or select a choice. |
| | This Object provides a special dynamic call blocking service to the company. |
| | When a caller enters a universal port they are given a numeric value that stays |
| | with them for the duration of the call. The caller may only reach an Object with |
| | the same numeric value or a “0” value. |
| OBJ/COS 459 | Object dedicated to one of a kind, client specific application. |
| | Used to automatically move callers to different parts of an application. |
| | Description: |
| | This Object provides a special dynamic call blocking service to the company. |
| | When a caller enters a universal port they are given a numeric value that stays |
| | with them for the duration of the call. The caller may only reach an Object with |
| | the same numeric value or a “0” value. |
| OBJ/COS 460 | Object dedicated to one of a kind, client specific application. |
| | Description: |
| | Plays an announcement twice and hangs up. |
| | This Object provides a special dynamic call blocking service to the company. |
| | When a caller enters a universal port they are given a numeric value that stays |
| | with them for the duration of the call. The caller may only reach an Object with |
| | the same numeric value or a “0” value. |
| OBJ/COS 462 | Object dedicated to one of a kind, client specific application. |
| | Description: |
| | Ring a phone without dialing an area code; if answered, announce the call; if busy |
| | or no answer, play a greeting and take the caller to a specific location in the |
| | client's configuration. While listening to the greeting the caller may enter an |
| | extension number or select a choice. |
| OBJ/COS 463 | Object dedicated to one of a kind, client specific application. |
| | Description: |
| | Ring a phone without dialing an area code; if answered, announce the call; if busy |
| | or no answer, play a greeting and take the caller to a specific location in the |
| | client's configuration. While listening to the greeting the caller may enter an |
| | extension number or select a choice. |
| OBJ/COS 464 | Object dedicated to one of a kind, client specific application. |
| | Description: |
| | This Object provides a specific client with an application that asks a series of |
| | questions one at a time and records the answers that a caller gives in their own |
| | voice. After the questions are asked, the caller is given the option of reviewing |
| | their answers and re-recording them if so desired. Upon acceptance of the |
| | answers by the caller, the answers to the questions are placed in a mailbox |
| | specified by the client for further action. |
| OBJ/COS 465 | Object dedicated to one of a kind, client specific application. |
| | Description: |
| | This Object provides a specific client with an application that asks a series of |
| | questions one at a time and records the answers that a caller gives in their own |
| | voice. After the questions are asked, the caller is given the option of reviewing |
| | their answers and re-recording them if so desired. Upon acceptance of the |
| | answers by the caller, the answers to the questions are placed in a mailbox |
| | specified by the client for further action. |
| OBJ/COS 468 | Object dedicated to one of a kind, client specific application. |
| | Description: |
| | This Object provides time of day control so callers hear different appropriate |
| | recordings at different times of day. |
| OBJ/COS 469 | Object dedicated to one of a kind, client specific application. |
| | Description: |
| | This Object provides time of day control so callers who press a “0” for the |
| | operator will reach different mailboxes during different times of day and after |
| | hours. One mailbox will ring a phone without dialing an area code; if answered, |
| | announce the call; if busy or no answer, play a greeting and take a message. The |
| | other mailbox takes a message without dialing a phone (normally used after hours |
| | or during lunch). While listening to the greeting the caller may enter an extension |
| | number or select a choice. |
| OBJ/COS 472 | Object dedicated to one of a kind, client specific application. |
| | Description: |
| | A mailbox placed in this Object has an intercept that can be controlled by time of |
| | day. |
| OBJ/COS 473 | (718) area code; blind transfer. |
| | Area code specific Objects. |
| | Description: |
| | A mailbox placed in this Object will dial a “1” and the above area code before |
| | calling an external telephone number and performing a blind transfer. The caller |
| | may dial no numbers and no messages may be recorded. |
| OBJ/COS 474 | Object dedicated to one of a kind, client specific application. |
| | Description: |
| | This Object provides time of day control so callers hear different appropriate |
| | recordings at different times of day. |
| OBJ/COS 475 | Object dedicated to one of a kind, client specific application. |
| | Description: |
| | The caller hears a recorded message and may enter an extension number or select |
| | a menu choice. No telephone numbers are dialed automatically upon a caller |
| | reaching this mailbox. If the caller takes no action, the greeting is played twice |
| | and the caller is dropped. A mailbox placed in this Object has a specific dedicated |
| | operator when a “0” is pressed. |
| OBJ/COS 511 | Ports level |
| | Ports level Object. |
| | This is a fail safe Object where callers are sent when there is no identifying |
| | number coming from the PBX portion of the POP or NOCC. This Object also |
| | comes into play when the Call Processor portion of the POP or NOCC doesn't |
| | know what else to do with the caller due to a software or ring cadence error. This |
| | Object contains the greetings that are played during different times of day and the |
| | operator's mailboxes that are used when a caller presses “0”. |

FIG. 10 located in the appendix is an example of an actual client's configuration with the names, addresses and telephone numbers changed to ensure the client's privacy. Actual verbiage spoken to the caller with a three-letter name in place of the actual client's name is also part of this example. Each client has a drawing of their configuration designed to be easily read by personnel responsible for the creation, manipulation and/or destruction of virtual environment applications. This also allows the drawing to be created rapidly and accurately by removing Objects from a master template drawing.

(See FIG. 10 in the Appendix)

1. (XXX) XXX-XXXX is the telephone number that receives callers who are forwarded or transferred in from a client location or who dial in directly.
2. M/B 2004,N,468 is a mailbox whose first four numbers match the last four digits of the telephone number that receives callers. 2004 is the mailbox number. N means there is no telephone number or extension number associated with this mailbox as a number to be dialed when the caller reaches mailbox 2004. 468 is the Object number. M/B 2004 has been placed in Object 468. Object 468 is dedicated to a one of a kind, client specific application. Object 468 provides time of day control so callers hear different appropriate recordings at different times of day.
3. Monday through Friday, (-MTWTF-) from 08:00 A.M-12:00 P.M. a moment of silence is played to the caller. The caller then hears the business hours greeting stored in mailbox 83500,N,1. Upon hearing any part of the greeting recorded in mailbox 83500, the caller may enter an extension number. This extension number is in reality a mailbox number. The caller may also select a choice that may be offered in the recording played to the caller such as 0 or 1-9. If the caller does nothing, the greeting will repeat and after several seconds of silence, the caller will hear “Goodbye” and be dropped. The caller will not be permitted to leave a message.

In the above table, Object 1 has the following definition:

Company greetings, no associated extension or telephone number, no
messages may be recorded. Play greeting twice and disconnect.
Non area code specific Object.
Description:
The caller hears a recorded message and may enter an extension number
or select a menu choice. No numbers are dialed automatically upon a
caller reaching this mailbox. If the caller takes no action, the greeting
is played twice and the caller is dropped.

4. When a mailbox such as (M/B) 83800,9979390,32 is reached by a caller selecting choice “0” which is the business hours intercept (the operator), the Object obtains the appropriate external dial tone and dials the telephone number 997-9390. Once the telephone number is dialed, CALL PULL-BACK is employed. (See issued U.S. Pat. No. 6,088,437, dated Jul. 11, 2000, and co-pending U.S. patent Attorney Docket No. 8006-0019-13, Confirmation No. 7593, application Ser. No. 09/556,439, entitled “A VIRTUAL VOICE NETWORK TOOL KIT, METHOD AND COMPUTER PROGRAM PRODUCT,” filed in the United States Patent and Trademark Office on Apr. 23, 1999, having common inventorship, the entire contents of all of which being incorporated herein by reference.)
5. A/C A/E to M/B 1077,9979390,32 means that if a caller leaves a message in M/B 83800, it will be “auto copied” to M/B 1077 and “auto erased” from M/B 83800. M/B 1077 will obtain the appropriate external dial tone from its Object, and depending on how the client wants the messaging waiting notification times set up in that M/B, message waiting notification will be performed to the telephone number 997-9390. At different times of day different client main greetings are played to the caller.
6. Default means all other times not specified and is typically used for after hours.
7. Max 1 Pre 8410 means that if the caller presses choice “1”, they will be taken to M/B 84101 and governed by Object 469.

The recordings spoken to the callers by a mailbox (M/B) number are as follows:

### XYZ Company Greetings

### M/B 83500

### Business Hours: Monday through Friday 8:00 A.M. to 12:00 P.M. 1:00 P.M. to 5:00 P.M.

Greeting: Thank you for calling XYZ Company. All available phone lines are utilized or our operator is assisting a previous caller. If you know your party's extension, please enter it now or press “0” for the operator. For our corporate directory, press “1”.

### M/B 83500, 83600 & 83700

Holiday Greeting. Put in as a message and prior to the holiday, do a greeting/message swap.

Thank you for calling XYZ Company. Our offices are closed for the holiday. If you would like to leave a message, we will be checking in; however, the operator will not be available to assist you. For the corporate directory, press “1”. Have a great holiday.

### M/B 83600

### Lunch Time: Monday-Friday 12:01 P.M. to 12:59 P.M.

Thank you for calling XYZ Company. We are closed for lunch and will return at 1:00 P.M If you know the extension of the person for whom you wish to leave a message, please enter it now. For our corporate directory, press “1”. To leave a message for our operator, press “0”.

### M/B 83700

### After Hours

Thank you for calling XYZ Company. Our office hours are Monday through Friday from 8:00 A.M to 5:00 P.M If you know the extension of the person for whom you wish to leave a message, please enter it now. For our corporate directory, press “1”. To leave a message for our operator, press “0”.

### M/B 83800

Name the Receptionist

### M/B 83900

### Name the Receptionist

Greeting: Please leave a message at the sound of the tone and we will return your call as soon as possible.

### M/B 84101

Greeting: The following is a list of our corporate personnel. At any time you may enter their extension number to leave a message.

| | | |
|---|---|---|
| First Name | Last Name | extension 1060 |
| First Name | Last Name | extension 1061 |
| First Name | Last Name | extension 1062 |
| First Name | Last Name | extension 1063 |
| First Name | Last Name | extension 1064 |
| First Name | Last Name | extension 1065 |
| First Name | Last Name | extension 1066 |
| First Name | Last Name | extension 1067 |
| First Name | Last Name | extension 1068 |
| First Name | Last Name | extension 1069 |
| First Name | Last Name | extension 1070 |
| First Name | Last Name | extension 1071 |
| First Name | Last Name | extension 1072 |
| First Name | Last Name | extension 1073 |
| First Name | Last Name | extension 1074 |
| First Name | Last Name | extension 1075 |
| First Name | Last Name | extension 1076 |
| The receptionist | | extension 1077 |

### M/B 1077

### Name the Receptionist

Greeting: You have reached (First Name, Last Name), the Receptionist. If you are calling concerning an office matter or to schedule an appointment, please leave your name and telephone number at the tone and we will get back to you.

### M/B 1060

Greeting: You have reached the voice mail of (First Name, Last Name). If you are calling concerning an office matter or to schedule an appointment, please call (First Name) at extension 1077 by pressing “1” now. If this is urgent, you may leave a one-minute voice message that will page (First Name). Please leave your message after the tone.

All M/Bs in the following list;

| | | |
|---|---|---|
| First Name | Last Name | M/B 1069 |
| First Name | Last Name | M/B 1061 |
| First Name | Last Name | M/B 1062 |
| First Name | Last Name | M/B 1063 |
| First Name | Last Name | M/B 1064 |
| First Name | Last Name | M/B 1065 |
| First Name | Last Name | M/B 1067 |
| First Name | Last Name | M/B 1068 |
| First Name | Last Name | M/B 1070 |
| First Name | Last Name | M/B 1071 |
| First Name | Last Name | M/B 1073 |
| First Name | Last Name | M/B 1074 |
| First Name | Last Name | M/B 1075 |
| First Name | Last Name | M/B 1076 |

Greeting: You have reached the voice mail of (First Name, Last Name). Please leave a detailed message at the sound of the tone and your call will be returned as soon as possible.

All M/Bs in the following list;

| | | |
|---|---|---|
| First Name | Last Name | M/B 1066 |
| First Name | Last Name | M/B 1072 |

Greeting: You have reached the voice mail of (First Name, Last Name). Please leave a detailed message at the sound of the tone and your call will be returned as soon as possible. For further options, press star* after your message. If you mark your message urgent, (First Name, Last Name) will be paged.

The processes set forth in the present description may be implemented using a conventional general purpose microprocessor programmed according to the teachings of the present specification, as will be appreciated to those skilled in the relevant art(s). Appropriate software coding can readily be prepared by skilled programmers based on the teachings of the present disclosure, as will also be apparent to those skilled in the relevant art(s).

The present invention thus also includes a computer-based product that may be hosted on a storage medium and may include instructions, which can be used to program a computer to perform a process in accordance with the present invention. The storage medium can include, but is not limited to, any type of disk including floppy disk, optical disk, CD-ROMS, and magneto-optical disks, ROMS, RAMs, EPROM's, EPROM's, flash memory, magnetic or optical cards, or any type of media suitable for storing electronic instructions.—Numerous modifications and variations of the present invention are possible in light of the above teachings and should be construed as part of the present invention.

1. A method for configuring a communications system utilizing CALL PULL-BACK technology as disclosed in the issued U.S. Pat. No. 6,088,437, dated Jul. 11, 2000, and co-pending U.S. patent Attorney Docket No. 8006-0019-13, Confirmation No. 7593, application Ser. No. 09/556,439, entitled “A VIRTUAL VOICE NETWORK TOOL KIT, METHOD AND COMPUTER PROGRAM PRODUCT,” filed in the United States Patent and Trademark Office on Apr. 23, 1999, having common inventorship, the entire contents of all of which being incorporated herein by reference, comprising the steps of:
preparing Objects as preprogrammed software constructs, said Objects being configured to perform predetermined functions when populated with a set of user definable parameters subsequently executed by processors;
inputting said set of user definable parameters into said Objects so as to perform said predetermined functions when executed by said processors.

2. A reconfigurable communications system, comprising:
processors data and voice input devices; and
memory encoded with Objects as preprogrammed software constructs, said Objects being configured to perform predetermined functions when populated with a set of user definable parameters input by said input devices and subsequently executed by the processors.

3. A business method of custom configuring a communication system, comprising the steps of:
collecting a set of communication system attributes from a predetermined source;
preparing an Object as a preprogrammed software construct, said Object being configured to perform a predetermined function when populated with said set of communication system attributes and subsequently executed by a processor; and
inputting said set of communication system attributes into said Object so as to perform said predetermined function when executed by said processor.

4. The business method of claim 3, wherein said step of collecting comprises collecting said set of communication system attributes from a client.

5. Methods of utilizing Objects by non-technical personnel, who understand the business needs of a client to create, manipulate and/or destroy virtual environment applications.

6. A method of configuring a communications system utilizing CALL PULL-BACK and Objects technology to process PSTN and VoIP callers utilizing:
analog, IP or cell phones, personal computer or PDAs with one device being able to talk to any other of these devices;
gateways, Gatekeepers, Directory servers, SIP servers, Unified Messaging servers, E-mail servers, Authentication and rating servers, Common Element Managers, Video and voice conferencing bridges and IVR IP Centrex servers:
Leased lines wireless TDM, Ethernet or VPNS as transport.

7. A method of configuring a communications system:
utilizing CALL PULL-BACK and Objects technology to provide services such as telephony, multi-media messaging, (voice mail, e-mail, fax, instant messaging, etc.); electronic document-sharing, the storage of electronic documents in secured locations, video and voice conferencing, plug in applications modules as well as disaster protection in a virtual environment application.

8. A method of configuring a communications system utilizing CALL PULL-BACK and Objects technology to provide disaster avoidance by processing callers to key employees' homes or alternate sites, or who dial or are forwarded in to the system from the TELCO Central Office under various no answer conditions.

9. A method of utilizing hardened POP and NOCC sites with back up power, equipment redundancy, and multiple voice and data transport connections, a meshed Optical Network to configure a highly disaster-resistant communications system utilizing CALL PULL-BACK and Objects technology.

10. A Marketing method consisting of-packaging the virtual environment applications products as computer software commonly found in boxes on store shelves and marketed on the Internet. The consumer purchasing the appropriate level of a virtual environment applications from a store or web site may then order the desired configuration or upgrade needed on a web site authorized to sell the products.

11. A method of configuring a communications system utilizing CALL PULL-BACK, Objects technology and a self healing optical network as transport for VOIP, Video Conferencing, messaging and data traffic allowing users to access a local class 5 switch without incurring Interlata or long distance charges.

12. A method of configuring a communications system utilizing CALL PULL-BACK, Objects technology, and a self healing optical Network to ensure a minimum amount of downtime.

13. A method of configuring a communications system utilizing CALL PULL-BACK, Objects technology, and a Meshed Optical Network as transport for VOIP, Video Conferencing, messaging and data traffic.

14. A method of configuring a communications system utilizing CALL PULL-BACK, Objects technology, and POPs deployed at strategic Class 5 switches and Data Centers in the LATA allowing all traffic to be considered local traffic.

15. A method of record keeping for each client that produces a drawing of their configuration designed to be easily read by personnel responsible for the creation, manipulation and/or destruction of virtual environment applications. This method allows the drawing to be rapidly and accurately created by removing Objects from a master drawing.

16. A method of documenting the spoken verbiage and user of a virtual environment application.

17. A method of documenting each Object used by the_personnel responsible for the creation, manipulation and/or destruction of virtual_environment application.
